(19) United States
(12) Patent Application Publication
(10) Pub. No.: US 2005/0117493 A1
(43) Pub. Date: Jun. 2, 2005

(54) Optical tape, optical tape cartridge, optical tape drive, and method for recording data on optical tape

(75) Inventors: Minoru Sueki, Odawara-shi (JP); Tetsuji Nishida, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/985,985

(22) Filed: Nov. 12, 2004

(30) Foreign Application Priority Data
Dec. 2, 2003 (JP) 2003-403411

(51) Int. Cl. G11B 7/00

(52) U.S. Cl. 369/96; 369/44.26

(57) ABSTRACT

Disclosed is an optical tape which contributes to a high recording density, and which achieves an enhanced flexibility in a width of a data track and a data format. The optical tape includes servo tracks being recorded thereon. These servo tracks contain respective servo signals, and are arranged lengthwise and adjacent to one another over a whole of a width or a part of the optical tape. Further, each of the servo tracks includes address signals being recorded thereon at predetermined intervals in isolation from the corresponding servo signals. These address signals indicate their respective locations of corresponding one of the servo tracks and their respective lengthwise locations on the optical tape. In addition, the servo signals are read from the respective servo tracks, and are used to adjust tracking on the optical tape.

### BACKGROUND OF THE INVENTION

1. Field of the Invention

Apparatuses and a method consistent with the present invention relate to an optical tape, an optical tape cartridge, an optical tape drive, and a method for recording data on an optical tape, which are all directed to record information using light.

2. Description of the Related Art

As the high recording density of information recording media advances, a demand for an accurate tracking technique becomes stronger. To meet this demand, at present, servo-tracking signals (servo signals) are recorded on an information recording medium beforehand, and data is recorded/reproduced on/from the recording medium, while the servo signals are read and the tracking on the medium is then adjusted based on the servo signals read.

However, as the recording density is further increased, the time that is required to pinpoint the location of data from a recording medium ends up being longer when the data is searched through the medium or when new data is appended thereon. This lowers the level of operating convenience. To prevent this degradation, information regarding the location of data is encoded into servo signals of a recording medium, so that data detection is made faster and more efficient. The above servo signals, however, occupy a large area of a recording medium, because servo signals and data are typically positioned on the medium, while being separated from each other. This may inhibit the high recording density, thereby causing a problem.

Optical tape systems can generally record/reproduce higher-density data than magnetic tape systems do. Further, optical tape systems are not configured to cause physical contact between a tape and a head as in magnetic tape systems. Accordingly, even if being repeatedly used by an optical tape system, a tape resists the deterioration. As examples of an information recording system using an optical tape, U.S. Pat. Nos. 6,140,301 and 6,141,312 specifications are cited.

On the other hand, within the content of the current technique, a width (pitch) of a data track and a location of the track on an optical tape depend on a system such as an optical tape drive, thereby making it difficult to produce different widths and locations on a single optical tape. To give an example, if an optical tape is recorded by a drive in such a way that the width of the data track is formed to be Tw (μm), then this tape cannot be recorded to form a Tw/2 (μm) width. Similarly, an optical tape, on which an old model of an optical tape drive has recorded data, may not always be recorded by a current model even if it can be reproduced. In other words, compatibility among models, systems, etc. of drives is lacking, thereby causing an additional problem.

Conventionally, methods for sequentially recording data on an optical tape have been applied, because it is difficult to record data at desired locations on the track, that is, randomly record data on the tape. Such a sequential data format seems inefficient in view of data accessibility.

The present invention has been conceived, taking the above disadvantages into account. The present invention is aimed at providing an optical tape, an optical tape cartridge, an optical tape drive, and a method for recording data on an optical tape, which all contribute to a high recording density, and which all achieve an enhanced flexibility in the width of the data track and a data format.

### SUMMARY OF THE INVENTION

In order to overcome the above problems, in the present invention, cells are formed on an optical tape as an information-recorded unit. Each cell contains an address, and can be arbitrarily erased and overwritten.

According to an aspect of the present invention, there is provided, an optical tape including a plurality of servo tracks being recorded on the optical tape. The servo tracks include respective servo signals, and are arranged lengthwise and adjacent to one another over a whole of a width or a part of the optical tape.

Further, each of the servo tracks includes a plurality of address signals being recorded thereon at predetermined intervals in isolation from the corresponding servo signals, the address signals indicating their respective locations of corresponding one of the servo tracks and their respective lengthwise locations on the optical tape,

In addition, the servo signals are read from the respective servo tracks, and are used to adjust tracking of a magnetic head on the optical tape.

With this optical tape, data bands of different widths can be recorded thereon. This is because any of the servo tracks arranged adjacent to one another can be read, even when the data bands of different widths are written on the optical tape. Therefore, the problem of the lacking compatibility is overcome.

The servo signal included in the servo track is composed of patterns, each of which is made up of a pair of lines being non-parallel with each other, and which are repeatedly arranged lengthwise. Further, the servo signal has an output, pulses of which are gradually varied in number, depending on a breadthwise position of corresponding one of the servo tracks.

The address signals which are recorded on the servo track in isolation from the servo signal may be positioned at predetermined intervals.

According to another aspect of the present invention, there is provided, an optical tape cartridge including a cartridge case, a reel being provided in the cartridge case, and the optical tape being wound around the reel. Further, the optical tape has a part on which reference information is recorded, the reference information including an index of data recorded on the optical tape and an address of the data.

With the optical tape cartridge, handling of the magnetic tape can be made easier.

Thanks to the reference information, the locations where data to be reproduced/recorded is placed are pinpointed for a short time by referring to the index and address included in the reference information. Further, since this reference information is located at the start point of the optical tape, it can be read right after the optical tape cartridge is set in a drive. Accordingly, the problem of the inefficient data accessibility is overcome.

According to yet another aspect of the present invention, there is provided, an optical tape drive for recording data on the optical tape cartridge, including:
(a) an optical tape running system for running the optical tape;
(b) an optical pickup unit including at least a servo signal-targeted optical pickup and a data-targeted optical pickup, the servo signal-targeted optical pickup for reading the servo signals and the address signals from the optical tape, the data-targeted optical pickup for recording data on the optical tape, and for reading the data and the reference information from the optical tape;
(c) a servo controller for adjusting tracking of the data-targeted optical pickup on the optical tape, based on the servo signals being read by the servo signal-targeted optical pickup;
(d) a control unit for controlling the optical tape running system and the optical pickup unit; and
(e) the control unit for determining a next recording address, based on the reference information being read by the data-targeted optical pickup, for driving the optical tape running system and moving the optical pickup unit, based on the address signals being read by the servo signal-target optical pickup, so that the data-targeted optical pickup is positioned at the determined recording address, and for applying a recording signal to the data-targeted optical pickup, based on the data to be recorded.

Further, if the reference information is recorded on a memory, then the optical tape drive may be provided with a memory reader that reads the reference information from the memory, and the control unit may determine the next recording address, based on the reference information being read by the memory reader.

The data-targeted optical pickup in the optical tape drive records the data by overwriting it on the servo signals and the address signals being included in the servo tracks. This overwriting process prevents the servo signals from occupying a large area of the optical tape. As a result, the problem of the inhibition of the high recording density can be eliminated.

According to still another aspect of the present invention, there is provided, a method for recording data on the optical tape in the optical tape cartridge by use of an optical pickup unit, the optical pickup unit including a servo signal targeted optical pickup, and a data-targeted optical pickup, the method including the steps of:
(a) reading reference information by use of the data-targeted optical pickup to determine a next recording address;
(b) running the optical tape and moving the optical pickup unit, based on address signals being read by the servo signal-targeted optical pickup, so that the data-targeted optical pickup is positioned at the determined recording address, and
(c) applying a recording signal to the data-targeted optical pickup, based on data to be recorded, thereby recording data on the optical tape.

Further, in the step (c), the data is recorded by being overwritten on the servo signals and the address signals being both included in the servo tracks.

In conclusion, with the optical tape, the optical tape cartridge, the optical tape drive, and the method for recording data on the optical tape according to the present invention, it is possible to attain the goal of providing an optical tape, an optical tape cartridge, an optical tape drive, and a method for recording data on the optical tape, which all contribute to the high recording density, and which all achieve the enhanced flexibility in the width of the track of data and a data format.

### BRIEF DESCRIPTION OF THE DRAWINGS

For a more complete understanding of the present invention and the advantages hereof, reference is now made to the following description taken in conjunction with the accompanying drawings wherein:

FIG. 1 is a schematic view depicting an optical tape according to an embodiment of the present invention;

FIG. 2A is an enlarged view depicting servo tracks written on the optical tape;

FIG. 2B is an enlarged view depicting servo patterns on the servo tracks;

FIG. 2C is a view depicting respective electric signals detected when a servo signal-targeted optical pickup traces lines A, B, C and D of FIG. 2A;

FIG. 3 is a schematic view depicting a servo writer according to the embodiment;

FIG. 4A is an enlarged view depicting servo tracks containing servo patterns of another variation;

FIG. 4B is an enlarged view depicting respective electric signals detected when the servo signal-targeted optical pickup traces lines A, B, C and D of FIG. 4A;

FIG. 5 is a view depicting a variation of the servo patterns of FIG. 4;

FIG. 6 is a perspective view depicting an optical tape cartridge according to the embodiment;

FIG. 7 is a schematic view depicting an optical tape drive according to the embodiment; and

FIG. 8 is a schematic view depicting the optical tape in use.

### DETAILED DESCRIPTION OF THE EXEMPLARY EMBODIMENTS OF THE INVENTION

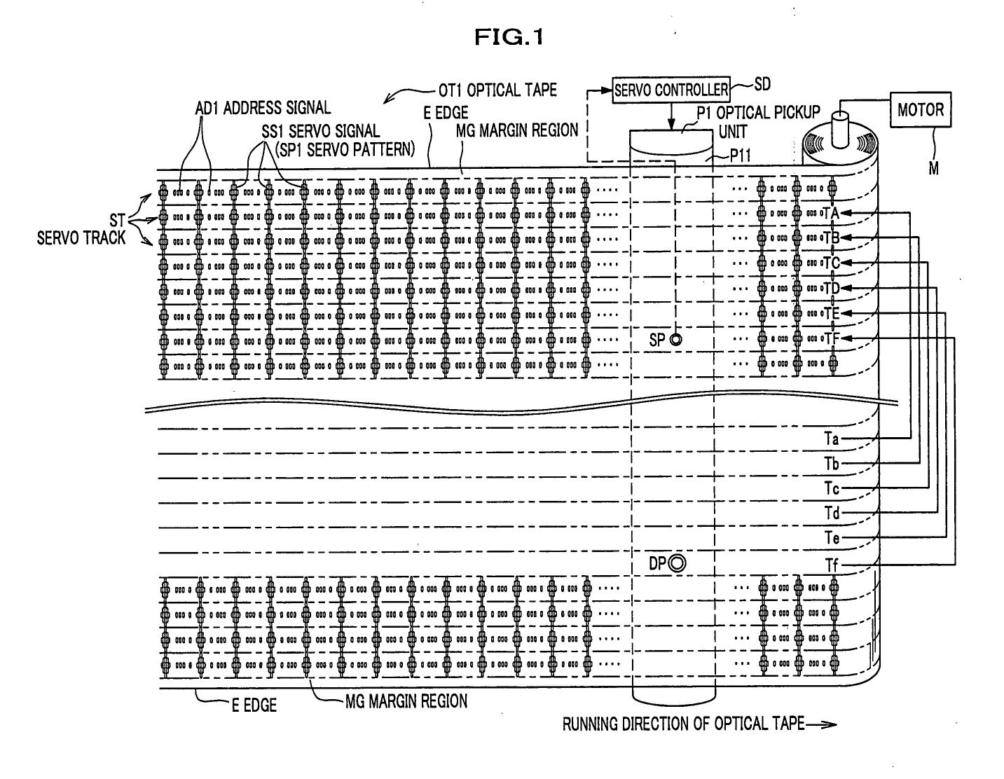

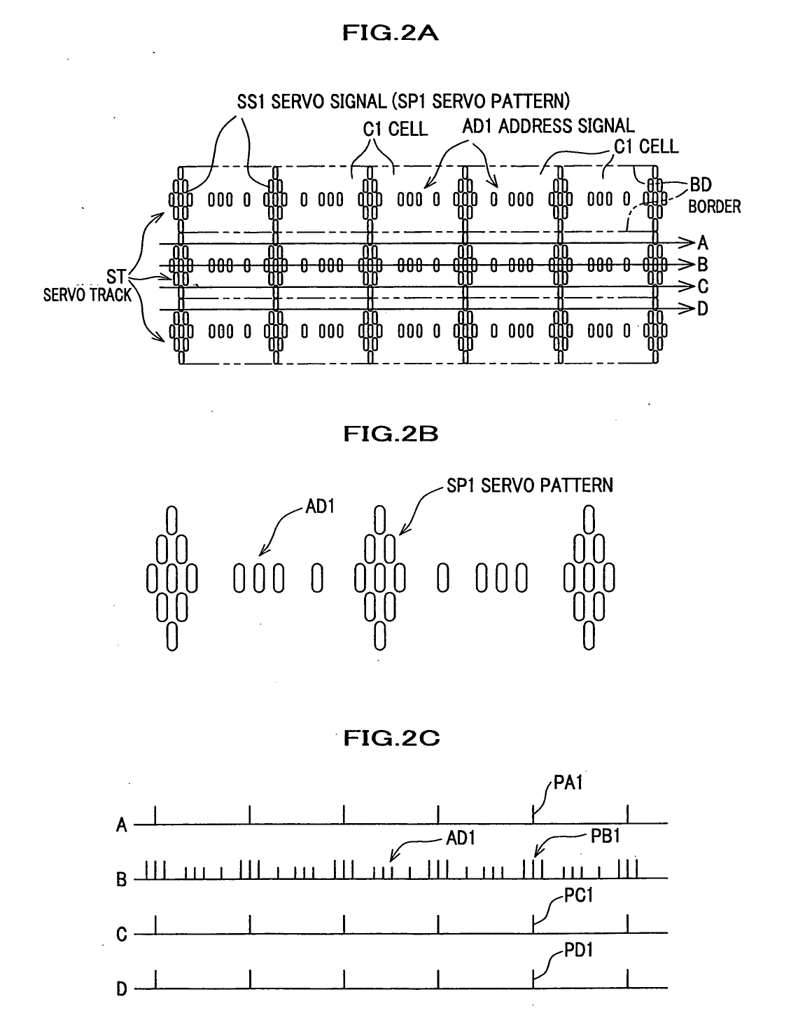

A description will be given in detail below of an embodiment of the present invention, with reference to accompanying figures as appropriate. FIG. 1 conceptually shows an optical tape according to the embodiment of the present invention, and FIGS. 2A, 2B and 2C show servo signals being recorded on the optical tape according to the embodiment.

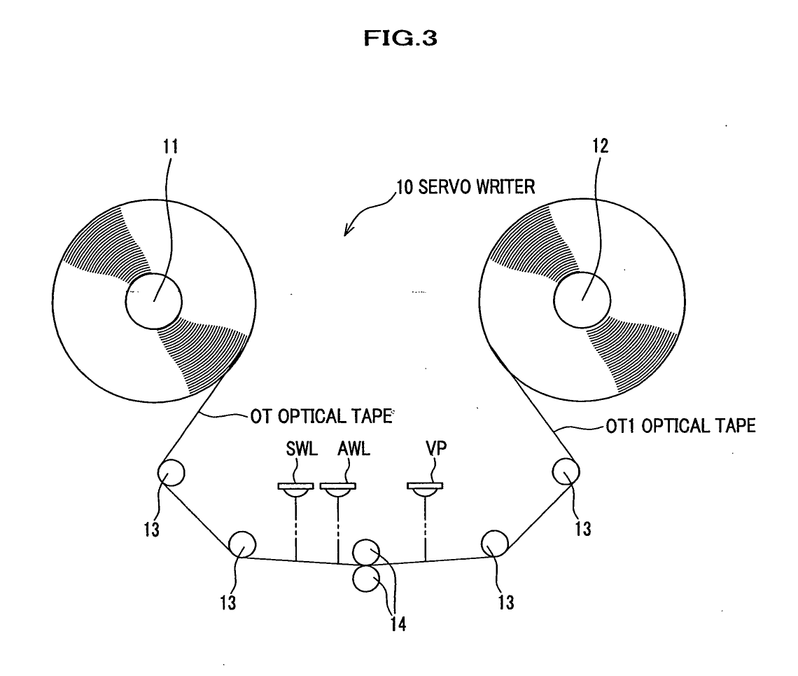

As shown in FIG. 1, an optical tape OT1 according to the embodiment has a surface on which servo signals SS1 are fully recorded by a servo writer (see FIG. 3) which will be described later. Each servo signal SS1 is spanned along a long side of the optical tape OT1, and includes optical-recorded regions, each of which has a predetermined pattern and which are repeatedly recorded lengthwise. Further, these servo signals SS1 are recorded on respective servo tracks ST. On both the long sides of the optical tape OT1, i.e., on both the sides of the group of the servo tracks which are arranged breadthwise adjacent to one another, respective blank margin regions MG are provided. The margin regions MG prevent the servo signals SS1 from extending off edges E of the optical tape OT1 when the servo signals SS1 are recorded. The optical tape OT1 is formed by, for example, applying a phase-change recording film on a base film. Note that this phase-change recording film has the property that its state is changed from crystalline to amorphous if being irradiated by a laser. Upon reproduction of data, the optical tape OT1 is irradiated by a laser with a low-power light beam, and the power difference between the light beams reflected from the crystalline and amorphous portions of the optical tape OT1 is detected, due to the difference between the refractive indexes thereof. The optical tape OT1 is wound by a motor M, and is thereby run in the direction from left to right in FIG. 1. Further, the optical tape OT1 is irradiated by an optical pickup unit P1 with a laser light beam, so that data is recorded/reproduced on/from the optical tape OT1.

On a surface P11 of the optical pickup unit P1, which faces the optical tape OT1, a servo signal-targeted optical pickup SP and data-targeted optical pickups DP are arranged at predetermined intervals. Tracking of the optical pickup unit P1 on the optical tape OT1 is controlled by a servo controller SD, based on an electric signal generated when the optical pickup SP reads the servo signal SS1.

As shown in FIG. 2A, the servo signals SS1 are recorded on the respective servo tracks ST, and each servo signal SS1 includes the servo patterns repeatedly formed lengthwise at predetermined intervals. As shown in FIG. 2B, each servo pattern SP1 has three optically recorded portions (phase-change portions) aligned in the middle and, further has two portions and one portion toward each edge of the optical tape OT1. In other words, the servo pattern SP1 has a substantially diamond shape.

The servo patterns SP1 are repeatedly recorded at substantially the same intervals as the width of the servo track ST, thereby constituting virtual cells C1 each of which is surrounded by the servo patterns SP1 and borders BD each placed between the servo tracks ST. This cell C1 serves as a minimum region where data is recorded.

On the center of each cell C1, an address signal AD1 is recorded. The address signal AD1 contains information designating a longitudinal location and a track location on the optical tape OT1. This information is encoded into the address signal AD1 as binary information. It is preferable that the address signals AD1 are not identical to one another in the optical tape OT1 of a single optical tape cartridge which will be described later. Further, the address signals AD1 are arranged so as to be incremented or decremented lengthwise or breadthwise. It is because, even when some of the address signals AD1 are lacked, the locations of these lacked signals can be pinpointed based on this regularity. In FIG. 2A, each cell C1 of the servo track ST is aligned with the corresponding cell C1 of the next servo track ST, but they may be shifted lengthwise from each other.

The servo signals SS1 and the address signals AD1 are written on the optical tape OT1 by a servo writer 10 shown in FIG. 3. This servo writer 10 includes a supply reel 11 that feeds the optical tape OT, take-up reel 12 that winds the optical tape OT1 on which the servo signals SS1 have been written, and a motor (not shown) that drives them. Further, the servo writer 10 includes multiple guide rollers 13 that guide the optical tape OT fed from the supply reel 11, pinch rollers 14 that runs the optical tape OT, OT1 with a constant speed, a servo write laser SWL that writes the servo signals SS1, an address write laser AWL that writes the address signals AD1, and a verifying optical pickup VP that verifies the written servo signals SS1 and address signals AD1.

The servo write laser SWL is fine-controlled so that it can be swung along the short side of the optical tape OT, and intermittently irradiates the laser light while being swung breadthwise at high speed, in response to running of the optical tape OT, thereby recording the servo signals SS.

Similarly, the address write laser AWL is fine-controlled so that it can be swung breadthwise, and intermittently irradiates the laser light while being swung breadthwise at high speed, in response to running of the optical tape OT, thereby recording the address signals AD1.

When the optical pickup SP reads the servo signals from the optical tape OT1, electric signals shown in FIG. 2C are detected. In FIG. 2C, the electric signals A, B, C and D are generated when the optical pickup SP traces lines A, B, C and D on the servo patterns and, then reads the servo signal there, respectively. When it traces the lines A, C and D, the optical pickup SP traverses the tips of the servo patterns SP1. The electric pulse signals having one pulse per one servo pattern SP1 are hence detected. When it traces the line B, the optical pickup SP traverses the center of the servo patterns SP1. The electric pulse signal having three pulses per one servo pattern SP1 is hence detected. In tracing the line B, the address signals AD1 are detected.

In this way, the pulse number of these electric signals, which are generated when this servo signal SS1 is read, is gradually varied depends on the breadthwise position where the optical pickup SP traverses. Thanks to this servo signal SS1, the optical pickup unit P1 is controlled so that the pulse number of electric signals detected is maximized during a predetermined period, thereby allowing the optical pickup SP to exactly trace the center of the servo track ST.

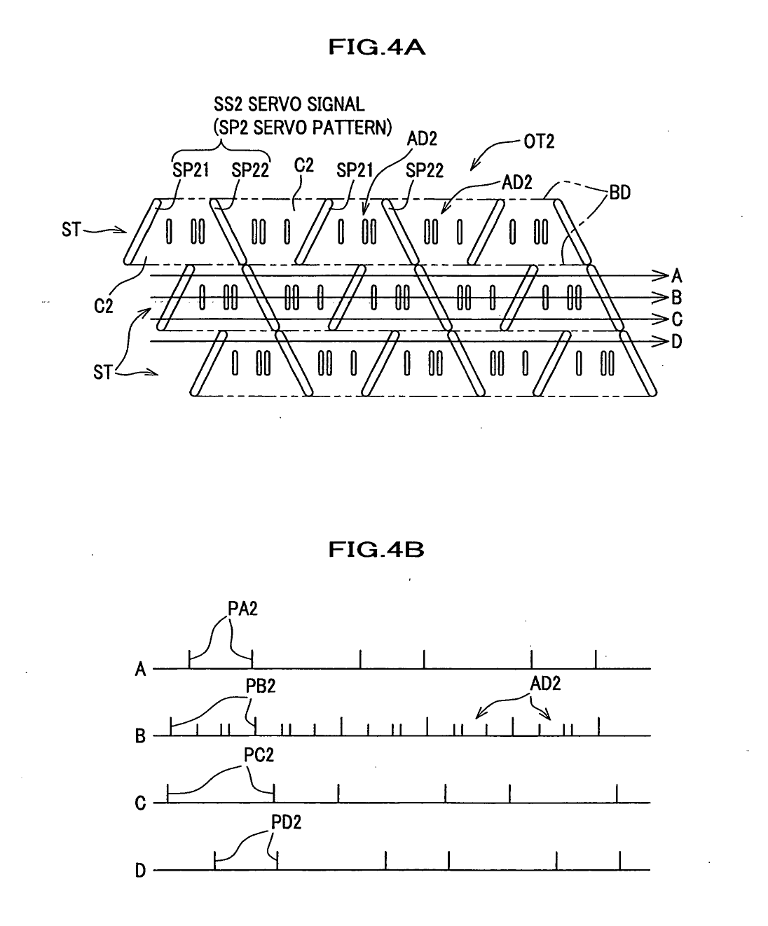

Some variations of the above servo pattern can be conceived. FIGS. 4A and 4B show a variation of servo patterns. Specifically, FIG. 4A shows servo patterns written on the optical tape, and FIG. 4B shows electric signals generated when an optical pickup SP reads the servo signal from the optical tape of FIG. 4A.

As shown in FIG. 4A, servo signals SS2 are recorded on respective servo tracks ST. Each servo signal SS2 includes servo patterns SP2 each composed of linear patterns SP21 and SP22. The pattern SP21 is formed to be inclined with respect to a long side of an optical tape OT2, and the pattern SP22 is formed to be symmetric to the pattern SP21. The above servo patterns SP2 are repeatedly written lengthwise at predetermined intervals. In this case, the patterns SP21 and SP22 between which upper interval is narrowed are paired in FIG. 4A. On the center of each cell C2 surrounded by the servo patterns SP2 and the borders BD each placed between the servo tracks ST, an address signal AD2 is written. This cell C2 serves as a minimum region where data is recorded.

When the optical pickup SP traces lines A, B, C and D shown in FIG. 4A to read the servo signal SS2 there, electric pulse signals A, B, C and D shown in FIG. 4B are detected, respectively. Specifically, when the optical pickup SP traverses the lines A and D, the electric pulse signals PA2 and PD2 having a short period are detected, respectively. This is because the optical pickup SP traverses the narrow portions of the servo patterns SP2. Meanwhile, when the optical pickup SP traces the line C, electric pulse signal PC2 having a long period is detected, because the optical pickup SP traverses the wide portions of the servo patterns SP2. In addition, when the optical pickup SP traces the line B, electric pulse signal having an intermediate period between those of the electric pulse signals A and C is detected. In this case, address signals AD2 are also detected.

In this way, the servo signal SS2 includes a pair of linear patterns which are not parallel to each other and which are repeatedly recorded. Thanks to this servo signal SS2, the breadthwise position of the optical pickup unit P1 is adjusted so that the detected electric pulse signal has a predetermined period, i.e., a period upon traversing of the line B, thus allowing the optical pickup SP to exactly trace the center of the servo track ST.

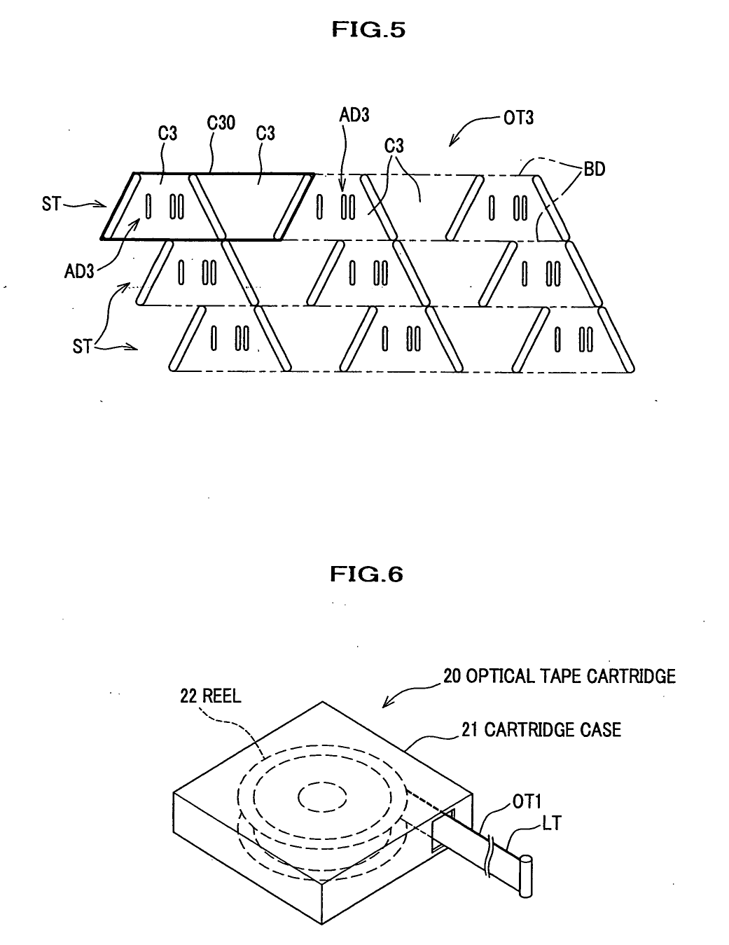

FIG. 5 shows another variation of the servo patterns. A servo pattern of FIG. 5 differs from that of FIG. 4 in that address signals AD3 are not written on cells C3 one by one, but alternately written thereon along the long side. In this case, a cell C30 which is surrounded by a heavy line is a combination of the two cells C3 adjacent to each other in the long side. This cell C30 serves as a minimum region.

As shown in FIG. 6, the optical tape OT1 may be wound around a reel 22 and, then accommodated in a cartridge case 21, thus constituting an optical tape cartridge 20. This cartridge structure makes handling of the optical tape OT1 easier. The wound optical tape OT1 contains, at any given location, reference-information regarding an index of data recorded on the tape OT1 itself and addresses of the data. It is preferable that this reference information is recorded from the start point of the optical tape OT1 to a predetermined location thereof. The reference information can thereby be read as soon as the optical tape cartridge 20 is set, thus increasing the access speed of the data. If the optical tape OT1 has, at its end, a reader tape LT used for drawing out the optical tape OT1 itself, then the reference information may be recorded on the optical tape OT1 after the reader tape LT is drawn out. Alternatively, if the reader tape LT has an optical record layer, then the reference information may be recorded on the reader tape LT itself.

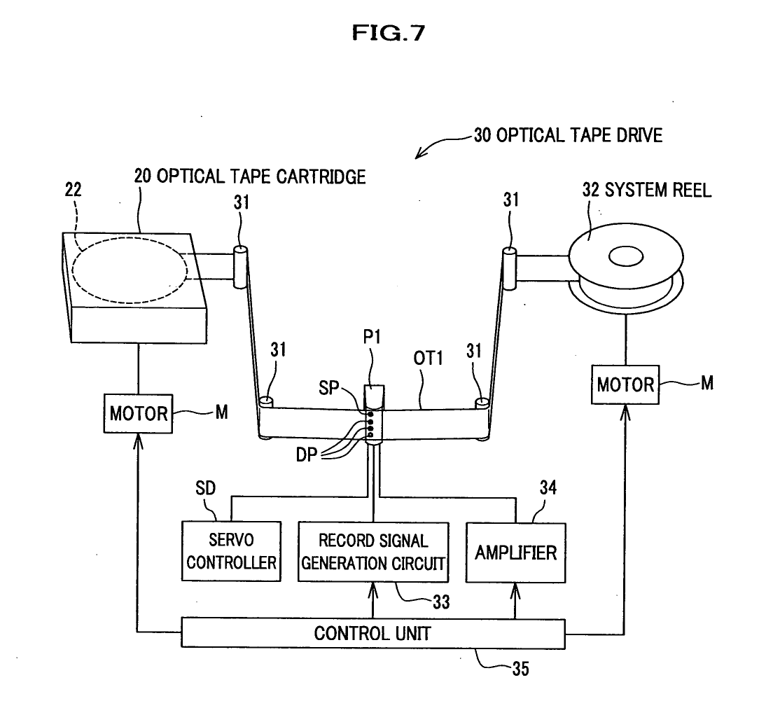

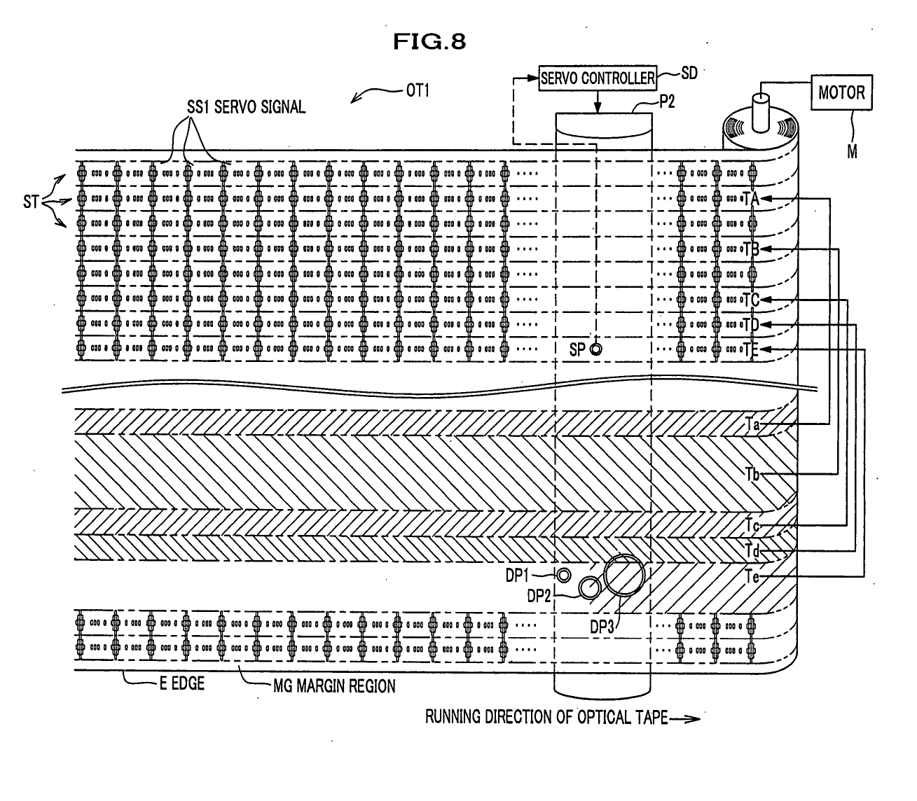

Next, a description will be given of an optical tape drive which records/reproduces data on/from the optical tape OT1 of the optical tape cartridge 20. FIG. 7 schematically shows an optical tape drive 30. The optical tape drive 30 includes, as an optical tape running system, a motor M that rotatably drives a reel 22 of the optical tape cartridge 20, a system reel 32 that winds the optical tape OT1 drawn from the optical tape cartridge 20, another motor M that rotatably drives the system reel 32, and multiple guide rollers 31 that guide the optical tape OT1. Further, the optical tape drive 30 includes the above-described optical pickup unit P1. This optical pickup unit P1 is provided with a servo signal-targeted optical pickup SP, and multiple data-targeted optical pickups DP arranged at predetermined intervals along the width of the optical tape OT1.

A servo controller SD allows the optical pickup unit P1 to track the optical tape OT1, based on the electric signal generated when the optical pickup SP reads the servo signal. The optical tape drive 30 further includes a record signal generation circuit 33, an amplifier 34 and a control unit 35. The record signal generation circuit 33 applies record signals to the optical pickups DP. The amplifier 34 amplifies voltage signals generated when the optical pickups DP read data. The control unit 35 controls the recording/reproducing operation and the tracking position of the optical pickup unit P1 through the record signal generation circuit 33 or the amplifier 34, as well as controls the above optical tape running system.

The control unit 35 uses the optical pickup DP to read reference information being recorded on a part of the optical tape OT1 of the optical tape cartridge 20 and, then determines a next recording address. Following this, the control unit 35 drives the optical tape running system and moves the optical pickup unit P1, so that the optical pickup DP is positioned at the determined recording address. Subsequently, the control unit 35 applies a record signal to the optical pickup DP through the record signal generation circuit 33, and thereby records data or acquires a reproduced signal through the amplifier 34.

Next, a description will be given of a method by which the above optical tape drive 30 drives the optical tape cartridge 20 (the optical tape OT1). In order to form data tracks of the same width on the optical tape OT1, and then, to record data thereon by use of the optical tape drive 30, the optical pickup unit P1 which has the optical pickup DP of the same recording width as shown in FIG. 1 is used. Specifically, when data is recorded on the tracks Ta, Tb, Tc, Td, Te and Tf, the servo signal SS1 is read from the tracks TA, TB, TC, TD, TE and TF, respectively, by the optical pickup SP. Subsequently, the servo controller SD adjusts the breadthwise position of the optical pickup SP so that the optical pickup SP traverses the center of the servo track ST, and at the same time, data is recorded on corresponding one of the tracks Ta, Tb, Tc, Td, Te and Tf by the optical pickup DP. In this case, the data is overwritten on the corresponding one of the servo tracks Ta, Tb, Tc, Td, Te and Tf that have contained the servo signal SS1 and the address signal AD1.

When data is reproduced from the servo tracks Ta, Tb, Tc, Td, Te and Tf, the servo signal SS1 is read from the tracks TA, TB, TC, TD, TE and TF, respectively, by the optical pickup SP as with the case of recording of data. At the same time, the data is read by the optical pickup DP while the tracking of the optical pickup unit P1 on the optical tape OT1 is adjusted based on the servo signal SS1 read. Note that the above method for recording data is also applied to the case where data is recorded on the region covering the multiple servo tracks ST. Concretely, this method makes it possible to record data tracks of multiple widths on the optical tape OT1.

When such data tracks of multiple widths are recorded on the optical tape OT1, an optical pickup unit P2 as shown in FIG. 8 may be used. This optical pickup unit P2 has optical pickups DP1, DP2 and DP3 of which recording widths differ from one another. The recording width of the optical pickup DP1 is equal to that of the servo track ST, the recording width of the optical pickup DP2 is equal to double the width of servo track ST, and the recording width of the optical pickup DP3 is equal to triple the width of the servo track ST.

When the above optical tape drive is used, if the data track Ta of which width is equal to that of the servo track ST is recorded on the optical tape OT1, then the recording process is done by the optical pickup DP1, while the servo signal SS1 is read from the track TA by the optical pickup SP and the tracking of the optical pickup DP1 is then adjusted based on the servo signals SS1 read. If the data track Tb of which width is equal to triple the width of the servo track is recorded on the optical tape OT1, then the recording process is done by the optical pickup DP3, while the servo signal SS1 is read from the track TB by the optical pickup SP and the tracking of the optical pickup DP3 is then adjusted based on the servo signals SS1 read.

Similarly, if the data track Tc or Td of which width is equal to that of the servo track ST is recorded, then the recording process is done by the optical pickup DP1, while the servo signal SS1 is read from the track TC or TD by the optical pickup SP and the tracking is then adjusted based on the servo signal SS1 read.

If the data track Te of which width is equal to double the width of the servo track ST is recorded, then the recording process is done by the optical pickup DP2, while the servo signal SS1 is read from the track TE by the optical pickup SP and the tracking is then adjusted based on the servo signals SS1 read.

Alternatively, a single optical pickup may be used to record the data tracks of different widths by varying an aperture of a lens of the optical pickup.

As described above, it is possible to record data tracks of different widths on the optical tape OT1. Conventionally, the servo tracks are formed merely on both the long sides of each of the data bands on the optical tape. In contrast, in this embodiment, the servo tracks ST are formed adjacent to one another, and the servo signal SS1 can therefore be read by the optical pickup SP, even if the servo track ST is overwritten by any of the optical pickups DP1, DP2 and DP3. In addition, each cell C1 of the servo track ST contains information regarding the lengthwise or breadthwise positions on the optical tape. Accordingly, even when the optical pickups DP1, DP2 and DP3 record data on any given location of the optical tape, the optical pickup SP reads the address signal AD1, thereby ensuring that the location where data is recorded is pinpointed.

If the information regarding a lengthwise location on the optical tape is contained in the servo signal SS1 as in a conventional technique such as LTO technology, then several hundreds of the servo patterns must be read in order to pinpoint the location. In contrast, in this embodiment, since each cell C1 or multiple cells C1 as in the variation in FIG. 5 contain the address signal AD1, the location can be pinpointed for a short time, thereby increasing the access speed of data. As described above, in this embodiment, it is possible to record the data tracks of different widths on desired locations of the optical tape. Moreover, since each minimum region where data is recorded contains the address signal, a data access equivalent to the random access can be realized.

Up to this point, the embodiment of the present invention has been described, but the present invention is not limited to this embodiment, and variations can be made as appropriate.

For example, in this embodiment, the servo tracks ST containing the servo signal SS1 are recorded over the full width of the optical tape OT1. However, the servo tracks ST may be recorded on a part of the optical tape MT1. It is because that, owing to the positions of the optical pickups SP and DP and the number of the optical pickups DP, the area where the servo signals SS1 can be accessed is limited. To give an example, the servo tracks ST may be formed only on a quarter of the full width of the optical tape OT1.

In this case, the data band is not overwritten on the servo tracks ST, but may be recorded only on the area where the servo tracks are not formed.

In this embodiment, the reference information is recorded on a part of the optical tape OT1, but the optical tape cartridge 20 is provided with a contact or non-contact memory (also called “cartridge memory”) composed of semiconductor memory cells, and the reference information may be recorded on this memory. In this case, a memory reader for reading the reference information is provided in the optical tape drive 30, and the control unit 35 may determine a next recording address based on the reference information read by the memory reader.

From the aforementioned explanation, those skilled in the art ascertain the essential characteristics of the present invention and can make the various modifications and variations to the present invention to adapt it to various usages and conditions without departing from the spirit and scope of the claims.

1. An optical tape comprising:
a plurality of servo tracks being recorded on the optical tape, the servo tracks which include respective servo signals, and which are arranged lengthwise and adjacent to one another over a whole of a width or a part of the optical tape; and
the servo tracks, each of which includes a plurality of address signals being recorded thereon at predetermined intervals in isolation from the corresponding servo signals, the address signals indicating their respective locations of corresponding one of the servo tracks and their respective lengthwise locations on the optical tape,
wherein the servo signals are read from the respective servo tracks, and are used to adjust tracking on the optical tape.

2. An optical tape according to claim 1,
wherein each of the servo signals includes patterns, each of which is made up of a pair of lines being non-parallel with each other, and which are repeatedly arranged lengthwise.

3. An optical tape according to claim 1,
wherein each of the servo signals has an output, pulses of which are gradually varied in number, depending on a breadthwise position of corresponding one of the servo tracks.

4. An optical tape cartridge, comprising:
a cartridge case,
a reel being provided in the cartridge case, and
the optical tape of claim 1, the optical tape being wound around the reel.

5. An optical tape cartridge, comprising:
a cartridge case,
a reel being provided in the cartridge case, and
the optical tape of claim 2, the optical tape being wound around the reel.

6. An optical tape cartridge, comprising:
a cartridge case,
a reel being provided in the cartridge case, and
the optical tape of claim 3, the optical tape being wound around the reel.

7. An optical tape cartridge according to claim 4,
wherein the optical tape has a part on which reference information is recorded, the reference information including an index of data recorded on the optical tape and an address of the data.

8. An optical tape cartridge according to claim 5,
wherein the optical tape has a part on which reference information is recorded, the reference information including an index of data recorded on the optical tape and an address of the data.

9. An optical tape cartridge according to claim 6,
wherein the optical tape has a part on which reference information is recorded, the reference information including an index of data recorded on the optical tape and an address of the data.

10. An optical tape cartridge according to claim 7,
wherein the reference information is recorded in a region ranging from a start point of the optical tape to a predetermined location thereof.

11. An optical tape cartridge according to claim 8,
wherein the reference information is recorded in a region ranging from a start point of the optical tape to a predetermined location thereof.

12. An optical tape cartridge according to claim 9,
wherein the reference information is recorded in a region ranging from a start point of the optical tape to a predetermined location thereof.

13. An optical tape cartridge according to claim 4, further comprising a contact or non-contact memory on which reference information is recorded, the reference information including an index of data recorded on the optical tape and an address of the data.

14. An optical tape drive for recording data on the optical tape cartridge according to claim 7, the optical tape drive comprising:
an optical tape running system for running the optical tape;
an optical pickup unit including at least a servo signal-targeted optical pickup and a data-targeted optical pickup, the servo signal-targeted optical pickup for reading the servo signals and the address signals from the optical tape, the data-targeted optical pickup for recording data on the optical tape, and for reading the data and the reference information from the optical tape;
a servo controller for adjusting tracking of the data-targeted optical pickup on the optical tape, based on the servo signals being read by the servo signal-targeted optical pickup;
a control unit for controlling the optical tape running system and the optical pickup unit; and
the control unit for determining a next recording address, based on the reference information being read by the data-targeted optical pickup, for driving the optical tape running system and moving the optical pickup unit, based on the address signals being read by the servo signal-targeted optical pickup, so that the data-targeted optical pickup is positioned at the determined recording address, and for applying a recording signal to the data-targeted optical pickup, based on the data to be recorded.

15. An optical tape drive for recording data on the optical tape cartridge according to claim 11, the optical tape drive comprising:
an optical tape running system for running the optical tape;
an optical pickup unit including at least a servo signal-targeted optical pickup and a data-targeted optical pickup, the servo signal-targeted optical pickup for reading the servo signals and the address signals from the optical tape, the data-targeted optical pickup for recording data on the optical tape, and for reading the data and the reference information from the optical tape;
a servo controller for adjusting tracking of the data-targeted optical pickup on the optical tape, based on the servo signals being read by the servo signal-targeted optical pickup;
a control unit for controlling the optical tape running system and the optical pickup unit; and
the control unit for determining a next recording address, based on the reference information being read by the data-targeted optical pickup, for driving the optical tape running system and moving the optical pickup unit, based on the address signals being read by the servo signal-targeted optical pickup, so that the data-targeted optical pickup is positioned at the determined recording address, and for applying a recording signal to the data-targeted optical pickup, based on the data to be recorded.

16. An optical tape drive for recording data on the optical tape cartridge according to claim 12, the optical tape drive comprising:
an optical tape running system for running the optical tape;
an optical pickup unit including at least a servo signal-targeted optical pickup and a data-targeted optical pickup, the servo signal-targeted optical pickup for reading the servo signals and the address signals from the optical tape, the data-targeted optical pickup for recording data on the optical tape, and for reading the data and the reference information from the optical tape;
a servo controller for adjusting tracking of the data-targeted optical pickup on the optical tape, based on the servo signals being read by the servo signal-targeted optical pickup;
a control unit for controlling the optical tape running system and the optical pickup unit; and
the control unit for determining a next recording address, based on the reference information being read by the data-targeted optical pickup, for driving the optical tape running system and moving the optical pickup unit, based on the address signals being read by the servo signal-targeted optical pickup, so that the data-targeted optical pickup is positioned at the determined recording address, and for applying a recording signal to the data-targeted optical pickup, based on the data to be recorded.

17. An optical tape drive for recording data on the optical tape cartridge according to claim 13, the optical tape drive comprising:
an optical tape running system for running the optical tape;
an optical pickup unit including at least a servo signal-targeted optical pickup and a data-targeted optical pickup, the servo signal-targeted optical pickup for reading the servo signals and the address signals from the optical tape, the data-targeted optical pickup for recording data on the optical tape, and for reading the data and the reference information from the optical tape;
a servo controller for adjusting tracking of the data-targeted optical pickup on the optical tape, based on the servo signals being read by the servo signal-targeted optical pickup;
a control unit for controlling the optical tape running system and the optical pickup unit; and
the control unit for determining a next recording address, based on the reference information being read by the data-targeted optical pickup, for driving the optical tape running system and moving the optical pickup unit, based on the address signals being read by the servo signal-targeted optical pickup, so that the data-targeted optical pickup is positioned at the determined recording address, and for applying a recording signal to the data-targeted optical pickup, based on the data to be recorded.

18. An optical tape drive according to claim 14,
wherein the data-targeted optical pickup overwrites data on the servo signals and the address signals, thereby recording the data.

19. An optical tape drive according to claim 15,
wherein the data-targeted optical pickup overwrites data on the servo signals and the address signals, thereby recording the data.

20. An optical tape drive according to claim 16,
wherein the data-targeted optical pickup overwrites data on the servo signals and the address signals, thereby recording the data.

21. An optical tape drive according to claim 17,
wherein the data-targeted optical pickup overwrites data on the servo signals and the address signals, thereby recording the data.

22. A method for recording data on the optical tape in the optical tape cartridge of claim 7 by use of an optical pickup unit, the optical pickup unit including a servo signal targeted optical pickup and a data-targeted optical pickup, the method comprising:
reading reference information by use of the data-targeted optical pickup to determine a next recording address;
running the optical tape and moving the optical pickup unit, based on address signals being read by the servo signal-targeted optical pickup, so that the data-targeted optical pickup is positioned at the determined recording address, and
applying a recording signal to the data-targeted optical pickup, based on data to be recorded, thereby recording data on the optical tape.

23 A method for recording data according to claim 22,
wherein the data is recorded by being overwritten on the servo signals and the address signals being included in the servo tracks.
